(19) United States
(12) Patent Application Publication
(10) Pub. No.: US 2014/0193146 A1
(43) Pub. Date: Jul. 10, 2014

(54) Apparatus and Method For Optical Transport Networks

(71) Applicants: Sergio Lanzone, Genova (IT); Annamaria Fulignoli, Latina (IT); Orazio Toscano, Genova (IT)

(72) Inventors: Sergio Lanzone, Genova (IT); Annamaria Fulignoli, Latina (IT); Orazio Toscano, Genova (IT)

(73) Assignee: Telefonaktiebolaget L M Ericsson (publ), Stockholm (SE)

(21) Appl. No.: 14/124,808

(22) PCT Filed: Jul. 4, 2011
(86) PCT No.: PCT/EP2011/061196

§ 371 Date: Feb. 28, 2014

(30) Foreign Application Priority Data
Jun. 9, 2011 (EP) 11169249.7

(51) Int. Cl. H04B 10/032

(52) U.S. Cl. CPC H04B 10/032
USPC 398/2

(57) ABSTRACT

An optical transport network comprises a first node and a second node adapted to communicate one or more lower order optical channel data unit (LO-ODU) traffic signals via a higher order optical channel data unit (HO-ODU) traffic signal. An adaptation function between a lower order optical channel data unit traffic signal and a higher order optical channel data unit traffic signal is modified to enable protocol information for bidirectional protection switching to be conveyed in one or more lower order optical channel data unit traffic signals that are conveyed between the first node and the second node using the higher order optical channel data unit traffic signal. This enables the protocol information to be used at a higher order optical channel data unit entity to perform bidirectional protection switching.

### TECHNICAL FIELD

The present invention relates to an apparatus and method for an Optical Transport Network (OTN), and in particular to an apparatus and method for providing protection switching mechanisms in an optical transport network, for example providing enhanced Optical Channel Data Unit level (ODUk) subnetwork connection (SNC) protection with inherent monitoring.

### BACKGROUND

The Optical Transport Network (OTN) is defined by a series of recommendations or standards coordinated by the International Telecommunication Union (ITU). ITU-T Recommendation G.873.1 defines the Automatic Protection Switching (APS) protocol and protection switching operation for the linear protection schemes of the Optical Transport Network at the Optical Channel Data Unit (ODUk) level.

In a linear protection architecture of an optical transport network, protection switching schemes may be generally classified as:
trail protection (at a section or path layer);
subnetwork connection protection (which in turn comprises inherent monitoring, non-intrusive monitoring, and sub-layer trail monitoring).

Subnetwork connection protection switching in optical transport networks are further defined in ITU-T Recommendation G.798.

FIG. 1 shows a first node, for example a ODUk cross connect node (Node 1), communicating with a second node, for example a ODUk cross connect node (Node 2), via an optical transport network 3. Node 1 is shown as comprising an input interface A (for example a traffic card), and first and second output interfaces (or traffic cards) B and C. Node 2 is shown as comprising first and second input interfaces D and E, and an output interface F. Protection switching in such a network is provided by duplicating an ODUk transmission over two independent paths along the optical transport network 3. Traffic may be transmitted along the path A→B→D, which is named the “working path” (W), with a duplicate transmission along the path A→C→E, which is named the “protecting path” (P). The destination node, Node 2, will select the traffic (i.e. ODUk traffic) from either the working path W or from the protecting path P depending on quality information. For example, traffic may be selected according to Signal Fail (SF) and Signal Degrade (SD) information detected by the second node at interfaces D and E which receive the working path W and protecting path P traffic, respectively.

The first node (Node 1) and second node (Node 2) can also be termed “head-end” and “tail-end”. For a given direction of transmission, the “head-end” of the protected signal is capable of performing a bridge function, which will place a copy of a normal traffic signal onto the protecting path P when required. The “tail-end” will perform a selector function, where it is capable of selecting a normal traffic signal either from the working path W, or from the protecting path P. In the case of bidirectional transmission, where both directions of transmission are protected, both ends of the protected signal will normally provide both bridge and selector functions. It will be appreciated that with bidirectional transmission, the input interfaces and output interfaces shown in FIG. 1 will comprise input/output interfaces.

The following architectures are possible in an optical transport network:

1+1—In a 1+1 architecture, a single normal traffic signal is protected by a single protecting path. The bridge at the head-end is permanent, and switching occurs entirely at the tail-end.

1:n—In a 1:n architecture, 1 or more normal traffic signal(s) are protected by a single protecting path. However, the bridge at the head-end is not established until a protection switch is required. In the case where n>1, it cannot be known which of the normal traffic signals should be bridged onto the protecting path, until a defect is detected on one of the protected signals.

In the case of bidirectional transmission, it is possible to choose either unidirectional or bidirectional switching. With unidirectional switching, the selectors at each end are fully independent. With bidirectional switching, an attempt is made to coordinate the two ends so that both have the same bridge and selector settings, even for a unidirectional failure. Bidirectional switching therefore requires an automatic protection switching (APS) and/or a protection communication channel (PCC) to coordinate the two endpoints.

Different types of subnetwork connection protection mechanisms are defined depending on the types of criteria used to select the traffic in the destination node (Node 2), or tail-end. As mentioned above, three types of subnetwork connection protection can be managed in current standards, these being inherent monitoring (SNC/I), non-intrusive monitoring (SNC/N), and sub-layer trail monitoring (SNC/S), all of which will be described in greater later in the application.

In ITU-T recommendation G.798, Section 14.1.1.1 defines the following sub-network connection protection schemes:
1+1 unidirectional having SNC/N, SNC/I and SNC/S protection without an APS protocol.
1+1 bidirectional having SNC/N, SNC/I and SNC/S protection with an APS protocol.
1:n bidirectional having SNC/I and SNC/S protection with an APS protocol

A problem with the subnetwork protection schemes defined above is that they do not allow bidirectional SNC/I protection switching for low order optical channel data units (LO-ODUs), where the automatic protection switching (APS) protocol is not available, for example when transmitting traffic through a high order optical channel data unit (HO-ODUk) server. This is because there is only one HO-ODUk path and one automatic protection switching (APS) channel at the higher order level, whereas there are many LO-ODUk signals.

Furthermore, other subnetwork connection protection switching mechanisms are not possible using the existing recommendations, such as 1:n bidirectional SNC/N protection switching.

### SUMMARY

It is an aim of the present invention to provide a method and apparatus for providing bidirectional protection switching in an optical transport network, that do not suffer from one or more of the disadvantages mentioned above.

According to a first aspect of the invention, there is provided a method for providing bidirectional protection switching in an optical transport network, the optical transport network comprising a first node and a second node adapted to communicate one or more lower order optical channel data unit (LO-ODU) traffic signals via a higher order optical channel data unit (HO-ODU) traffic signal. The method comprises the steps of modifying an adaptation function between a lower order optical channel data unit (LO-ODU) traffic signal and a higher order optical channel data unit (HO-ODU) traffic signal to enable protocol information for bidirectional protection switching to be conveyed in the respective one or more lower order optical channel data unit traffic signals. The protocol information is used to perform bidirectional protection switching.

The invention has the advantage of enabling bidirectional SNC/I protection switching for low order optical channel data units (LO-ODUs) over high order optical channel data unit (HO-ODUk) servers.

The invention also enables 1:n bidirectional SNC/N protection switching to be performed.

According to another aspect of the invention, there is provided an optical transport network for providing bidirectional subnetwork connection protection switching. The network comprises a first node and a second node adapted to communicate one or more lower order optical channel data unit (LO-ODU) traffic signals via a higher order optical channel data unit (HO-ODU) traffic signal. A processor is adapted to modify an adaptation function between a lower order optical channel data unit traffic signal and the higher order optical channel data unit traffic signal to enable protocol information for bidirectional protection switching to be conveyed in the respective one or more lower order optical channel data unit traffic signals.

According to another aspect of the invention, there is provided a node for use in an optical transport network. The node comprises an input interface for receiving one or more lower order optical channel data unit traffic signals, and an output interface for outputting a higher order optical channel data unit traffic signal. A multiplexer is adapted to multiplex the one or more lower order optical channel data traffic signals into the higher order optical channel data unit traffic signal. A processor is adapted to control the operation of the multiplexer, such that protocol information for bidirectional protection switching is mapped into a respective header portion of the one or more lower order optical channel data unit traffic signals.

According to another aspect of the present invention, there is provided a method in a node of an optical transport network. The method comprises the steps of receiving one or more lower order optical channel data unit (LO-ODU) traffic signals, and multiplexing the one or more lower order optical channel data (LO-ODU) traffic signals into a higher order optical channel data unit (HO-ODU) traffic signal, and outputting the higher order optical channel data unit (HO-ODU) traffic signal. The multiplexing step comprises mapping protocol information for bidirectional protection switching into a respective header portion of the one or more lower order optical channel data unit (LO-ODU) traffic signals.

According to another aspect of the invention, there is provided a node for use in an optical transport network. The node comprises an input interface for receiving a higher order optical channel data unit traffic signal, which comprises one or more lower order optical channel data unit traffic signals. An output interface is provided for outputting one or more lower order optical channel data unit traffic signals. A demultiplexer is adapted to demultiplex the one or more traffic signals from the higher order optical channel data unit traffic signal. A processor is adapted to control the operation of the demultiplexer, such that protocol information for bidirectional protection switching is unmapped from a respective header portion of the one or more lower order optical channel data unit traffic signals.

According to another aspect of the present invention, there is provided a method in a node of an optical transport network. The method comprises the steps of receiving a higher order optical channel data unit traffic signal, which comprises one or more lower order optical channel data unit (LO-ODU) traffic signals, demultiplexing the one or more lower order optical channel data unit (LO-ODU) traffic signals from the higher order optical channel data unit (HO-ODU) traffic signal, and outputting one or more lower order optical channel data unit traffic signals. The demultiplexing step comprises unmapping protocol information for bidirectional protection switching from a respective header portion of the one or more lower order optical channel data unit (LO-ODU) traffic signals.

### BRIEF DESCRIPTION OF THE DRAWINGS

For a better understanding of the present invention, and to show more clearly how it may be carried into effect, reference will now be made, by way of example only, to the following drawings in which:

FIG. 1 shows a basic optical transport network having optical data channel unit (ODUk) subnetwork connection protection switching;

FIG. 2 shows an optical transport network transmitting optical channel data unit (ODUk) traffic over an optical channel transport unit (OTUk) server, and having SNC/I protection switching;

FIG. 3 shows an optical transport network transmitting optical channel data unit (ODUk) traffic over a higher order optical channel data unit (HO-ODUk) server, and having SNC/I protection switching;

FIG. 4 shows an optical transport network transmitting optical channel data unit (ODUk) traffic, over a tandem connection monitoring (TCM) link, and having SNC/N protection switching;

FIG. 5 shows an optical transport network transmitting optical channel data unit (ODUk) traffic, over a tandem connection monitoring (TCM) link, and having SNC/S protection switching;

FIG. 6 shows how an automatic protection switching (APS) protocol is transported by dedicated bytes in the overhead of optical channel data unit (ODUk) traffic;

FIG. 7 shows an overview of the possible linear optical transport network protection architectures and related monitoring mechanisms as defined by ITU-T standards;

FIG. 8 shows an example of how low order optical channel data unit (ODUk) traffic is transmitted over a higher order optical channel data unit (HO-ODUk) server;

FIG. 9a shows the steps performed in an optical transport network according to an embodiment of the present invention;

FIG. 9b shows the steps performed at a head-end of an optical transport network according to an embodiment of the present invention;

FIG. 9c shows the steps performed at a tail-end of an optical transport network according to an embodiment of the present invention;

FIG. 10a shows a node of an optical transport network according to an embodiment of the present invention, for example when adapted to operate as a source or head-end;

FIG. 10b shows a node of an optical transport network according to an embodiment of the present invention, for example when adapted to operate as a sink or tail-end;

FIG. 10c shows an optical transport network according to an embodiment of the present invention, comprising first and second nodes;

FIG. 11 shows an example of a source functional block diagram of a transmitting or head-end of an optical transport network as defined at present by ITU-T standards;

FIG. 12 shows an example of a modified source functional block of a transmitting or head-end of an optical transport network, according to an embodiment of the present invention;

FIG. 13 shows an example of a sink functional block diagram of a receiving or tail-end of an optical transport network as defined at present by ITU-T standards; and

FIG. 14 shows an example of a modified sink functional block diagram of a receiving or tail-end of an optical transport network, according to an embodiment of the present invention.

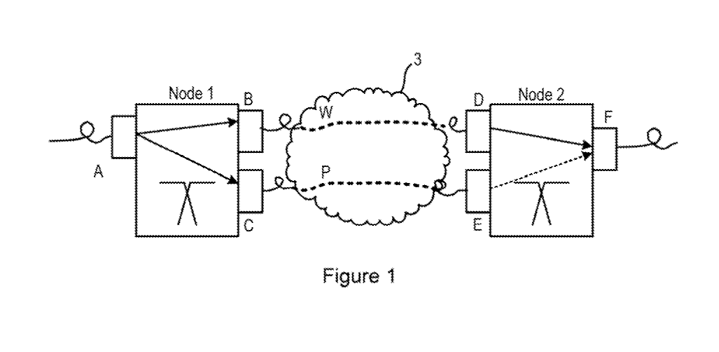

### DETAILED DESCRIPTION

The embodiments below will be described in relation to subnetwork protection switching mechanisms for optical transport networks (OTNs). It is noted that any input interfaces or output interfaces referenced in the various embodiments for a given direction of transmission will become input/output interfaces when operating in a bidirectional mode of operation.

As mentioned above, different types of subnetwork connection protection can be used in current standards, according to the type of criteria used to select traffic in the destination nodes. The different types of subnetwork connection protection mechanisms include inherent monitoring (SNC/I), non-intrusive monitoring (SNC/N), and sub-layer trail monitoring (SNC/S), which will be described in greater detail below.

Subnetwork connection protection using inherent monitoring (known as SNC/I) protects against failures in the server layer (i.e. server layer trail and server/ODUk adaptation function).

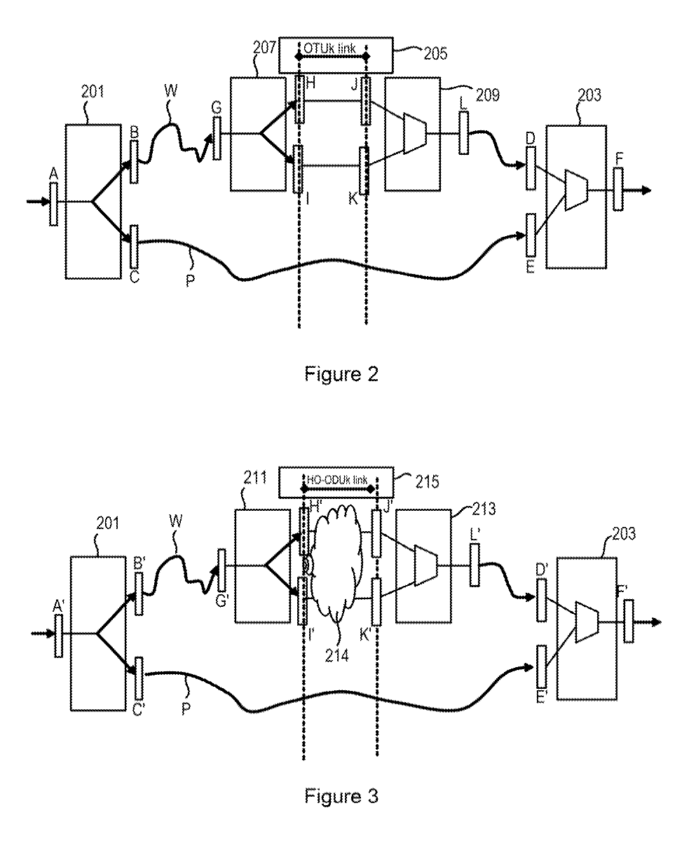

FIG. 2 shows an example of a network comprising a first node 201 and a second node 203. The first node 201 comprises an input interface A, a first output interface B and a second output interface C. The second node 203 comprises a first input interface D, a second input interface E, and an output interface F. The first node 201 and second node 203 represent the Optical Channel Data Unit-k (ODUk) layer of the OTN network layering.

In FIG. 2 there is no SNC/I provided between the first node 201 and the second node 203, since there is no single server transporting, un-terminated, the protected ODUk from the first node 201 to the second node 203, both on the working path W and the protecting path P. On the protecting path P there is shown an Optical Channel Transport Unit-k (OTUk) server that satisfies the above criteria, while on the working path W the OTUk is terminated and regenerated by the intermediate nodes, or network elements (NEs) 207 and 209. The NEs 207 and 209 perform, among other things, a mapping/demapping or multiplexing/demultiplexing operation. In the architecture of FIG. 2, only subnetwork connection protection using non-inherent monitoring (SNC/N) can be used between the first node 201 and the second node 203. However, SNC/I can be used between the NEs 207 and 209 where both the working path W and protecting path P have an un-terminated OTUk server, as explained further below.

Traffic between the first node 201 and the second node 203 is transmitted via a first path A→B→D, the working path W, and a duplicate path A→C→E, the protecting path P. The protection path is represented by a direct connection between C and E. Over this link the ODUk is transported over a single OTUk. Traffic flow is only shown in one direction, but it will be appreciated that traffic can also be sent from the second node 203 to the first node 201. In the first path, i.e. the working path W, there is shown an OTUk link 205, between the first NE 207 and a second NE 209, and more specifically between H→J and I→K, respectively. Along this working path the ODUk crosses the first and second NEs 207, 209.

The first NE 207 comprises an input interface G, a first output interface H and a second output interface I. The second NE 209 comprises a first input interface J, a second input interface K, and an output interface L. Traffic between the first NE 207 and the second NE 209 is transmitted via a first path G→H→J, the working path, and a duplicate path G→I→K, the protecting path. Traffic flow is only shown in one direction, but it will be appreciated that traffic can also be sent from the second NE 209 to the first NE 207. The second NE 209 may be adapted to perform SNC/I protection switching based on OTUk termination criteria at the OTUk termination of the interfaces J and K. Thus, as mentioned above, SNC/I can be set between the first NE 207 and the second NE 209 where both the working path H→J and protecting path I→K have an un-terminated OTUk server.

In summary, it can be seen from FIG. 2 that ODUk SNC/N can be provided between nodes 201 and 203, and SNC/I between nodes 207 and 209, where the server of the ODUk is an OTUk.

FIG. 3 shows another example of a network, comprising a first node 201 and a second node 203. The first node 201 comprises an input interface A′, a first output interface B′ and a second output interface C′. The second node 203 comprises a first input interface D′, a second input interface E′, and an output interface F′. The first node 201 and second node 203 represent the Optical Channel Data Unit-k (ODUk) layer.

As above, traffic between the first node 201 and the second node 203 is transmitted via a first path A′→B′→D′, the working path, and a duplicate path A′→C′→E′, the protecting path. Traffic flow is only shown in one direction, but it will be appreciated that traffic can also be sent from the second node 203 to the first node 201. As with FIG. 2, there is no SNC/I provided between the first node 201 and the second node 203, since there is no single server transporting, un-terminated, the protected ODUk from the first node 201 to the second node 203, both on the working path W and the protecting path P.

In the first path, or working path W, there is shown a third node 211 and a fourth node 213. The third node 211 comprises an input interface G′, a first output interface H′ and a second output interface I′. The fourth node 213 comprises a first input interface J′, a second input interface K′, and an output interface L′. The third node 211 and fourth node 213 are not connected via a simple OTUk link as shown in FIG. 2, but via an OTN network 214. The OTN network 214 may have several NEs along the path of the ODUk, where the single NEs are connected via OTUk links between them. In the OTN network 214 shown in FIG. 3 the ODUk is transported multiplied inside a higher order ODUk (an HO-ODUk). This HO-ODUk is generated in the third node 211 and is terminated in the fourth node 213, and is the server transporting the ODUk along the network between the third node 211 and the fourth node 213.

Traffic between the third node 211 and the fourth node 213 is transmitted via a first path G′→H′→J′, the working path, and a duplicate path G′→I′→K′, the protecting path. Traffic flow is only shown in one direction, but it will be appreciated that traffic can also be sent from the fourth node 213 to the third node 211. In this network architecture OTUK cannot be used since there is not a single OTUk transporting the ODUk from the third node 211 to the fourth node 213. In this scenario, the protection between the first and second nodes 201 and 203 is still an SNC/N, while the protection between the third and fourth nodes 211 and 213 may be adapted to perform unidirectional SNC/I protection switching based on HO-ODUk termination criteria at the HO-ODUk termination of the interfaces J′ and K′. In other words, unidirectional SNC/I can be provided between the third and fourth nodes 211 and 213 where the server is an HO-ODUk and not the OTUk as shown in FIG. 2.

In FIGS. 2 and 3, the trail termination sink of an OTUk[V] or HO-ODUkP (i.e. when the protected ODUk is a lower order ODUj [LO-ODUj] transported inside an HO-ODUk that is terminated by the ingress interface) the server layer provides the signal fail (trail signal fail, TSF) and signal degrade (trail signal degrade, TSD) protection switching criteria via the OTUk[V]/ODUk_A or ODUkP/ODU[i]j_A functions (server signal fail, SSF, and server signal degrade, SSD). In other words, defect detection is performed at the higher layer, and no defect detection is performed at the lower ODUj layer itself.

In the case of SNC/I where the criteria for the protection is the quality of the server, SSF and SSD may be used as the criteria for the protection, while in the case of SNC/N, the TSF and TSD maybe used as the criteria, the quality of the protected ODUk itself.

A second form of subnetwork connection protection using non-intrusive monitoring (known as SNC/N) uses client layer information to protect against failures or degradation in the client layer. Protection switching is triggered by a non-intrusive monitor of the ODUkP trail or ODUkT sub-layers trails at the tail-end of the protection group.

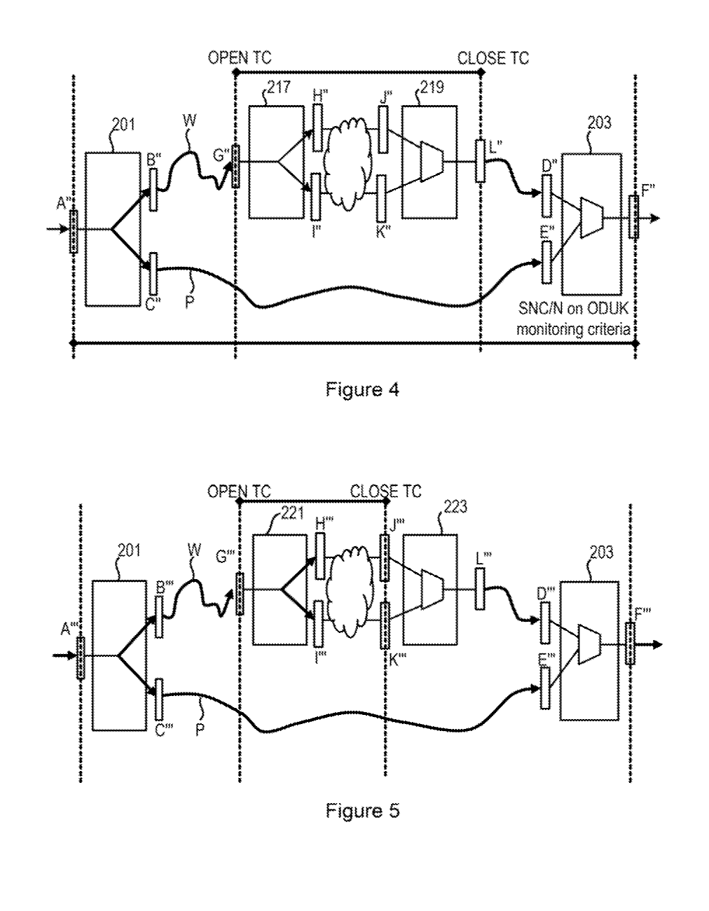

FIG. 4 shows an example of subnetwork connection protection using non-intrusive monitoring (SNC/N) between a first node 201 and a second node 203. The first node 201 comprises an input interface A″, a first output interface B″ and a second output interface C″. The second node 203 comprises a first input interface D″, a second input interface E″, and an output interface F″. The first node 201 and second node 203 represent the Optical Channel Data Unit-k (ODUk) layer. The second node 203 is adapted to perform SNC/N protection switching based on ODUk monitoring criteria.

Traffic between the first node 201 and the second node 203 is transmitted via a first path A″→B″→D″ and a duplicate path A″→C″→E″. Traffic flow is only shown in one direction, but it will be appreciated that traffic can also be sent from the second node 203 to the first node 201. FIG. 4 differs from FIGS. 2 and 3 in that different criteria are used to protect the ODUk between a third node 217 and a fourth node 213. The criteria used to protect the ODUk is Tandem Connection Monitoring (TCM) between the third node 217 and the fourth node 219.

The third node 217 comprises an input interface G″, a first output interface H″ and a second output interface I″. The fourth node 219 comprises a first input interface J″, a second input interface K″, and an output interface L″. Traffic between the third node 217 and the fourth node 219 is transmitted via a first path G″→H″→J″, the working path, and a duplicate path G″→I″→K″, the protecting path. Traffic flow is only shown in one direction, but it will be appreciated that traffic can also be sent from the fourth node 219 to the third node 217. The fourth node 219 may be adapted to perform SNC/N protection switching based on tandem connection monitoring criteria. Interfaces A″ and F″ comprise ODUk generation and termination, respectively.

Interfaces G″ and L″ comprise ODUkT generation and termination, respectively. ODUk path non-intrusive monitoring is performed at interfaces D″ and E″, while ODUkT non-intrusive monitoring is performed at interfaces J″ and K″.

Another type of subnetwork connection protection using sublayer trail monitoring (known as SNC/S) uses a trail (for example Tandem Connection Monitoring, TCM) created in a sublayer to protect against failures. Some portion of the original trail's capacity is over written such that the part of connection that is of interest can be directly monitored by the trail created in a sublayer.

Protection switching is triggered by defects detected at the ODUkT sublayer trail (TCM). An ODUkT sublayer trail is established for each working and protection entity. Protection switching is therefore triggered only on defects of the protected domain.

FIG. 5 shows an example of subnetwork connection protection using sublayer trail monitoring (SNC/S) between a first node 201 and a second node 203. The first node 201 comprises an input interface A′″, a first output interface B′″ and a second output interface C′″. The second node 203 comprises a first input interface D″, a second input interface E″, and an output interface F′″. The first node 201 and second node 203 represent the Optical Channel Data Unit-k (ODUk) layer of the OTN network layering. As mentioned above, there is no SNC/I provided between the first node 201 and the second node 203, since there is no single server transporting, un-terminated, the protected ODUk from the first node 201 to the second node 203, both on the working path W and the protecting path P.

Traffic between the first node 201 and the second node 203 is transmitted via a first path A′″→B′″→D′″, the working path W, and a duplicate path A′″→C′″→E′″, the protecting path P. Traffic flow is only shown in one direction, but it will be appreciated that traffic can also be sent from the second node 203 to the first node 201. In the first path there is shown a Tandem Connection Monitoring (TCM) link between a third node 221 and a fourth node 223.

The third node 221 comprises an input interface G″, a first output interface H′″ and a second output interface I′″. The fourth TCM node 223 comprises a first input interface J″, a second input interface K′″, and an output interface L′″. Traffic between the third node 221 and the fourth node 223 is transmitted via a first path G′″→H′″→J′″ and a duplicate path G′″→I′″→K′″. Traffic flow is only shown in one direction, but it will be appreciated that traffic can also be sent from the fourth node 223 to the third node 221. The fourth node 223 may be adapted to perform SNC/S protection switching based on tandem connection monitoring criteria. Interfaces G′″, J′″ and K′″ provide ODUkT generation and termination.

As mentioned above, in ITU-T recommendation G.798, Section 14.1.1.1 defines the following sub-network connection protection schemes:
1+1 unidirectional SNC/N, SNC/I and SNC/S protection without an APS protocol.
1+1 bidirectional SNC/N, SNC/I and SNC/S protection with an APS protocol.
1:n bidirectional SNC/I and SNC/S protection with an APS protocol

The automatic protection switching (APS) is a protocol that allows, when an SNC protection is set on a bidirectional path (i.e. the transmission is protected both in the Node1→Node2 and Node2→Node1 directions) to have the two sides of the protection to be always on the same path.

For example, if, in case of a failure, the traffic in the Node1→Node 2 direction is selected from the P path, then the APS protocol will also force the traffic to be selected from the P path in the Node2→Node1 direction even if, in that direction, the W path has not failed.

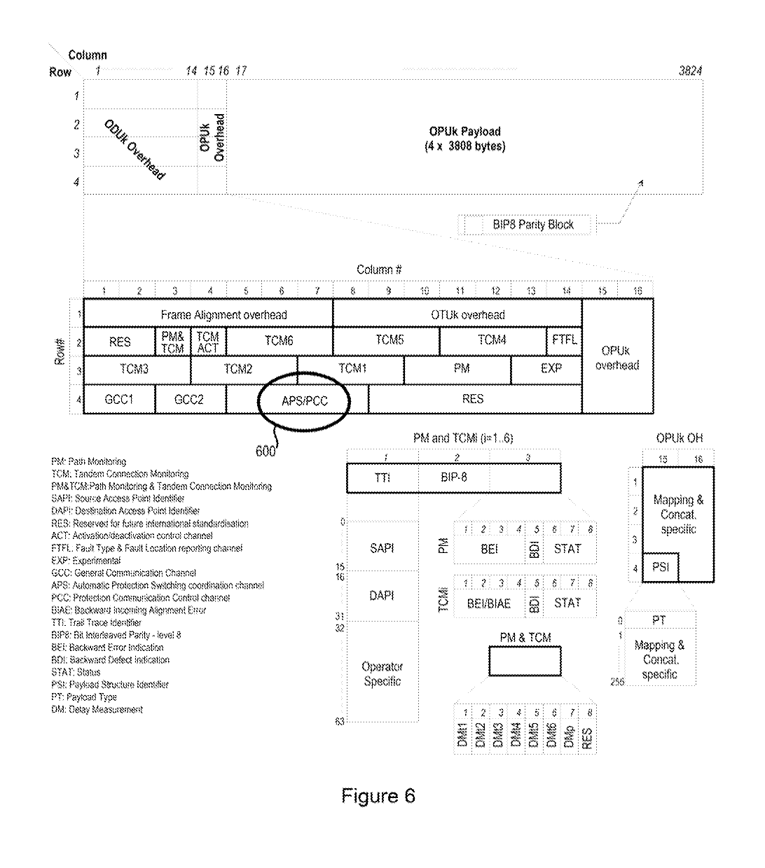

The APS protocol is transported by dedicated bytes in the ODUk overhead (ODUk-OH). FIG. 6 shows the position of the APS bytes in the ODUk overhead, highlighted by reference 600.

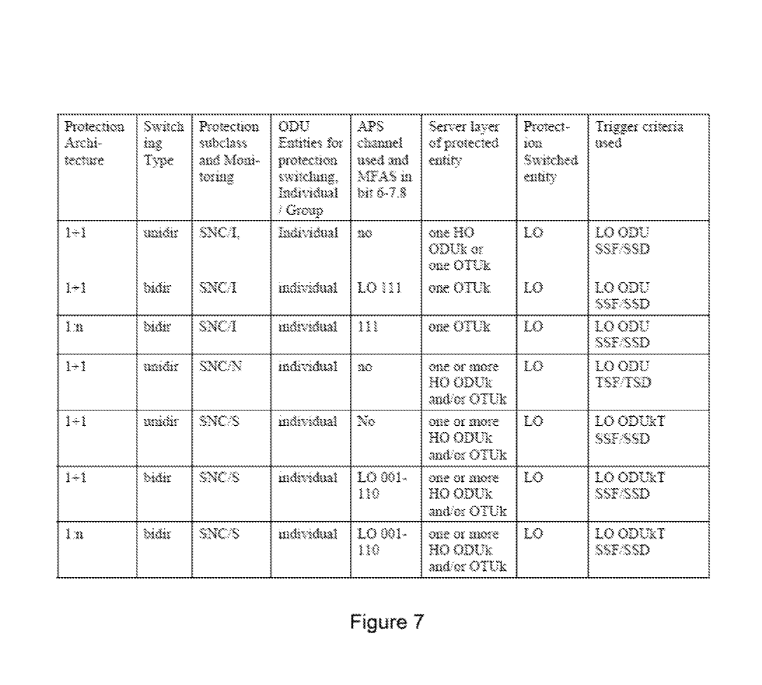

FIG. 7 shows an overview of linear optical transport network protection architectures and related monitoring, according to ITU-T Recommendation G.873.1. As can be seen from this table, bidirectional subnetwork connection protection switching with inherent monitoring (SNC/I) is not possible for a low order optical channel data unit (LO-ODUj), when the server of the low order optical channel data unit (LO-ODUj) is a higher order optical channel data unit (HO-ODUk). In other words, SNC/I is only allowed when using a OTUk server.

Thus, bidirectional lower order optical channel data unit subnetwork connection protection switching (LO-ODU SNC/I) cannot be supported over higher order optical channel data unit (HO-ODUk). This is because there is only one HO-ODUk path APS channel, and there may be many LO-ODUk signals transported in the same HO-ODUk.

The reason is that no sharing of the APS channel of the HO-ODUk by multiple LO-ODUk protection switching instances is defined in the ITU-T recommendation.

There is only one APS byte in the higher order optical channel data unit (HO-ODUk) entity. In fact as specified in ITU-T G.798, the ODUk/ODUij adaptation function (i.e. the function that provides the switching criteria for the SNC/I in the case of a HO-ODUk server), as defined today, is able to access only the APS bytes of the HO-ODUk, but not access the APS bytes of the LO-ODUj.

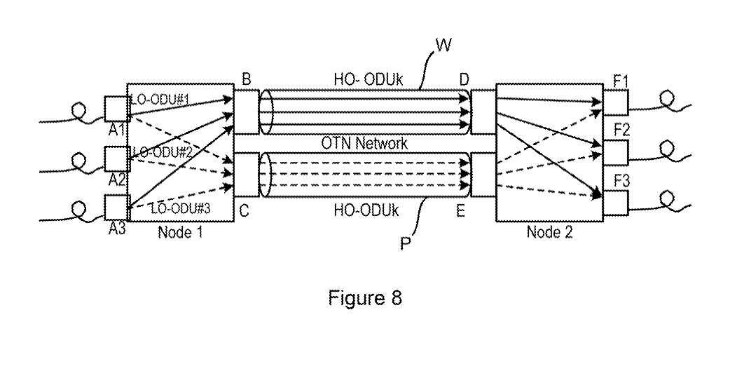

Referring to FIG. 8, an example is shown whereby a higher order optical channel data unit (HO-ODUk) server is transporting several lower order optical channel data units (LO-ODUj) from Node1 to Node2.

If it is supposed that SNC/I protection switching is set for three lower order optical channel data unit (LO-ODU) signals, (for example, LO-ODU#1, LO-ODU#2, LO-ODU#3), the working path W path for all the three LO-ODUj is transported by a higher order optical channel data unit (HO-ODUk) server from interface B to interface D, while the protecting path P is transported by the HO-ODUk from interface C to interface E (shown by dotted lines). In FIG. 8 only the direction from Node1 to Node2 is shown. In a bidirectional scenario the symmetric path from Node2 to Node1 is present as well.

As stated above, the bidirectional SNC/I protection switching of the three LO-ODUj traffic signals cannot rely on the automatic protection switching (APS) protocol of the higher order optical channel data unit (HO-ODUk). In fact, supposing that Node2 detects a defect on the working path W path of traffic signal LO-ODU#1 that causes the switch of the SNC/I for the LO-ODU#1 on the protecting path P, therefore the automatic switching protocol (APS) should require Node1 to collect the traffic from the protecting path as well.

However, since the APS byte is at the HO-ODUk level, it is common between all the LO-ODUj traffic signals. Therefore when Node1 receives the APS it is unable to determine which of the LO-ODUj traffic signals has to be selected from the protecting path P.

According to embodiments of the invention, the ODUk/ODUij adaptation function is enhanced or adapted to enable extraction/insertion of the APS bytes of the lower order optical data channel units (LO-ODUs).

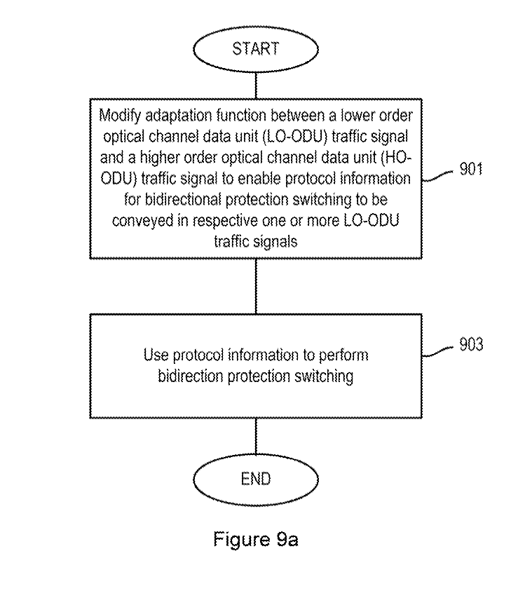

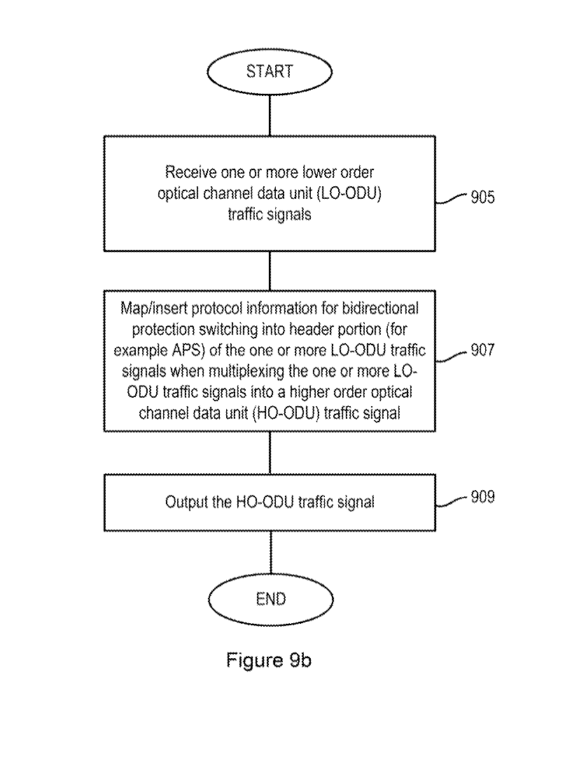

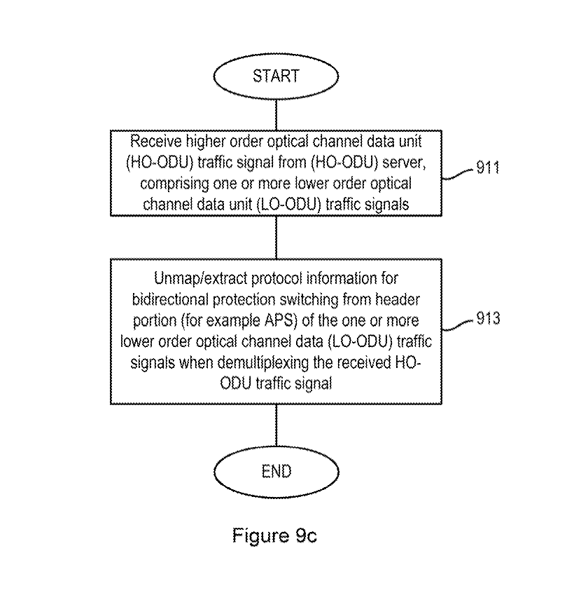

FIG. 9a shows a method performed in an optical transport network according to an embodiment of the invention. The method enables bidirectional protection switching, for example subnetwork connection inherent monitoring (SNC/I) protection switching, to be provided in an optical transport network comprising a first node and a second node adapted to communicate lower order optical channel data unit (LO-ODU) information, wherein communication between the first node and second node takes place via a higher order optical channel data unit (HO-ODU) traffic signal, server or entity.

In step 901 the adaptation function between one or more lower order optical channel data unit (LO-ODU) traffic signals and a higher order optical channel data unit (HO-ODU) traffic signal is modified to enable protocol information for bidirectional protection switching to be conveyed in the respective one or more lower order optical channel data unit (LO-ODU) traffic signals. For example, the protocol information may be inserted in a header portion of each lower order optical channel data unit traffic signal (for example an automatic protection switching (APS) header portion of each LO-ODU traffic signal). This enables the APS data of the LO-ODU traffic signals to be made available at the adaptation function between the HO-ODUk layer and the LO-ODUk layer According to G.798, an adaptation function is provided between one layer and another (for instance between the OTUk layer and the ODUk layer, or between the HO-ODUk layer and the LO-ODUK layer), whereby the adaptation function performs certain functions. For example, the criteria for the switching of the ODUk SNC/I are given by a function that adapts the protected ODUk to its server. In the case of a OTUk server, then the SSF and SSD criteria are given by the OTUk/ODUk adaptation function, while in the case of a HO-ODUk server, the criteria are given by the ODUj/ODUi adaptation function.

In step 903 protocol information (the automatic protection switching (APS) data) in the one or more LO-ODU traffic signals is used to perform bidirectional protection switching. The adaptation function between the HO-ODUk and the LO-ODUk levels is therefore modified to allow the insertion/extraction of the APS bytes to/from the overhead (OH) of the LO-ODUks.

FIG. 9b shows a method relating to a modified LO-ODUk to HO-ODUk adaptation function performed at a head-end, i.e. source or transmitting node, of an optical transport network, according to an embodiment of the invention. In step 905 the head-end receives one or more lower order optical channel data unit (LO-ODU) traffic signals which are to be transmitted over a higher order optical channel data unit (HO-ODU) server (via a HO-ODU traffic signal). In step 907, protocol information for bidirection protection switching is mapped, or inserted, into the respective APS header portion (for example APS bytes) of the one or more LO-ODU traffic signals. The protocol information may be inserted when the one or more LO-ODU traffic signals are multiplexed into a higher order optical channel data unit (HO-ODU) traffic signal. The head-end then transmits the one or more LO-ODU traffic signals via a higher order optical channel data unit (HO-ODU) traffic signal or server, by outputting the HO-ODU traffic signal, step 909. It is noted that, according to one embodiment, the head-end may be configured to always map the LO-ODU APS protocol information to the higher level, for example because the node will always transmit to a HO-ODU server. Alternatively, the head-end may be configured to adaptively perform the mapping only when the traffic is being sent via a HO-ODU traffic signal or server.

In the LO-ODUk to HO-ODUk adaptation function of the head-end the one or more LO-ODUk traffic signals (for example “n” LO-ODUk traffic signals) are mapped into the container of the HO-ODUk. The LO-ODUk overhead (LO-ODUk OH) already provides an APS field (shown as reference 600 in FIG. 6 above), but in the present G.798 standard, the adaptation function does not insert any protocol information for bidirection protection switching in this field. According to embodiments of the invention, the LO-ODUk to HO-ODUk adaptation function of the head-end is modified to insert such APS protocol information.

FIG. 9c shows a method performed at a tail-end, i.e. sink or receiving node, of an optical transport network, according to an embodiment of the invention. In step 911 the tail-end receives a higher order optical channel data unit (HO-ODU) traffic signal, for example from a HO-ODU server or link, comprising one or more lower order optical channel data unit (LO-ODU) traffic signals. In step 913 protocol information for bidirectional protection switching is unmapped or extracted from each lower order optical channel data unit (LO-ODU) traffic signal contained in the received (HO-ODU) traffic signal. This comprises extracting or unmapping the protocol information for bidirectional protection switching of the LO-ODUk traffic signals from the header portion (for example APS bytes) of the overhead of the one or more LO-ODUk traffic signals, for example when the one or more LO-ODUk traffic signals are de-multiplexed from the HO-ODUk server.

The tail-end then can then apply protection switching to the one or more LO-ODU traffic signals using the extracted protocol information for each of the respective LO-ODU traffic signals.

In the same way as the head-end, at present, as defined in ITU-T G.798, the LO-ODUk to HO-ODUk adaptation function of the tail-end does not extract any protocol for bidirectional protection from the overhead of the LO-ODUk traffic signals. Embodiments of the invention modify the LO-ODUk to HO-ODUk adaptation function of the tail-end to access such information.

It will therefore be appreciated that, in this way, each LO-ODUj will effectively have an independent APS, i.e. corresponding to the one available in the lower order optical channel data unit overhead (LO-ODUj OH), to implement ODUk SNC/I protection even in the case of a HO-ODUk server.

Embodiments of the invention modify the ODUk/ODUij adaptation function in order to allow the access of the APS of the LO-ODUj (i.e. extraction in the Receiver/Sink direction, insertion in the Transmitter/Source direction).

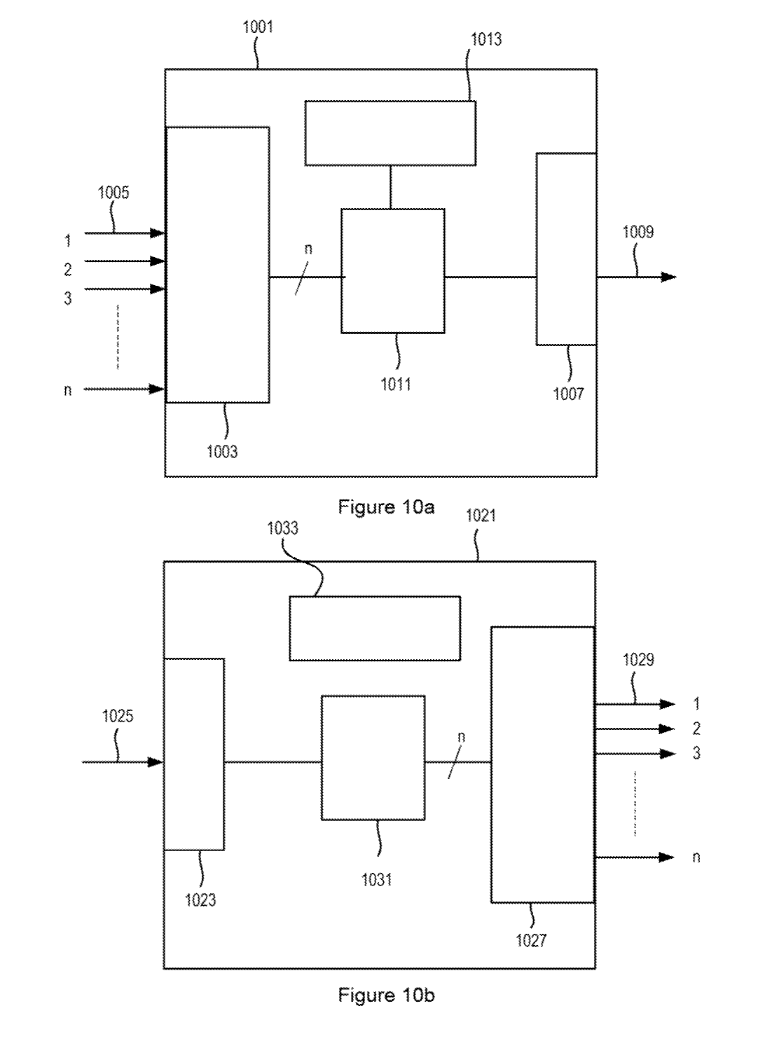

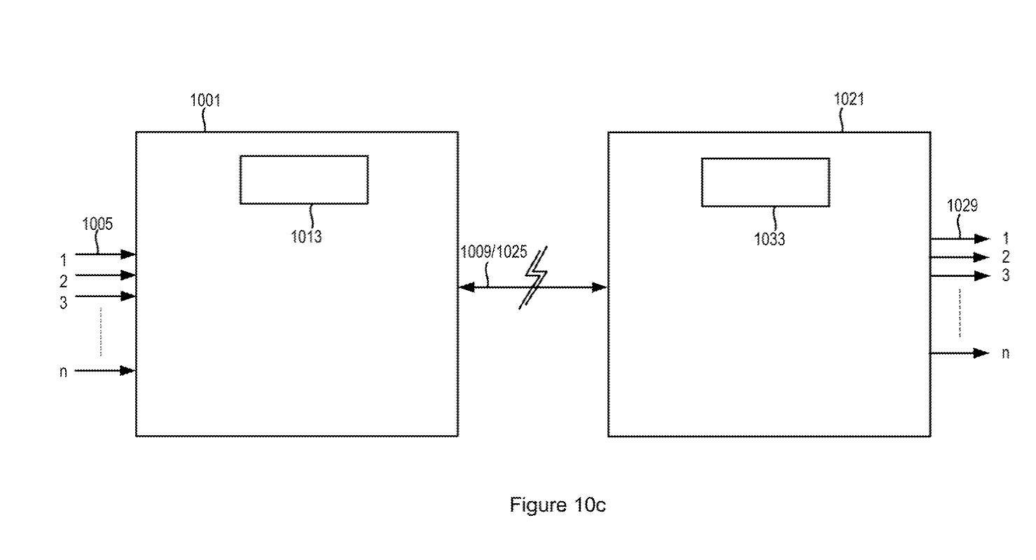

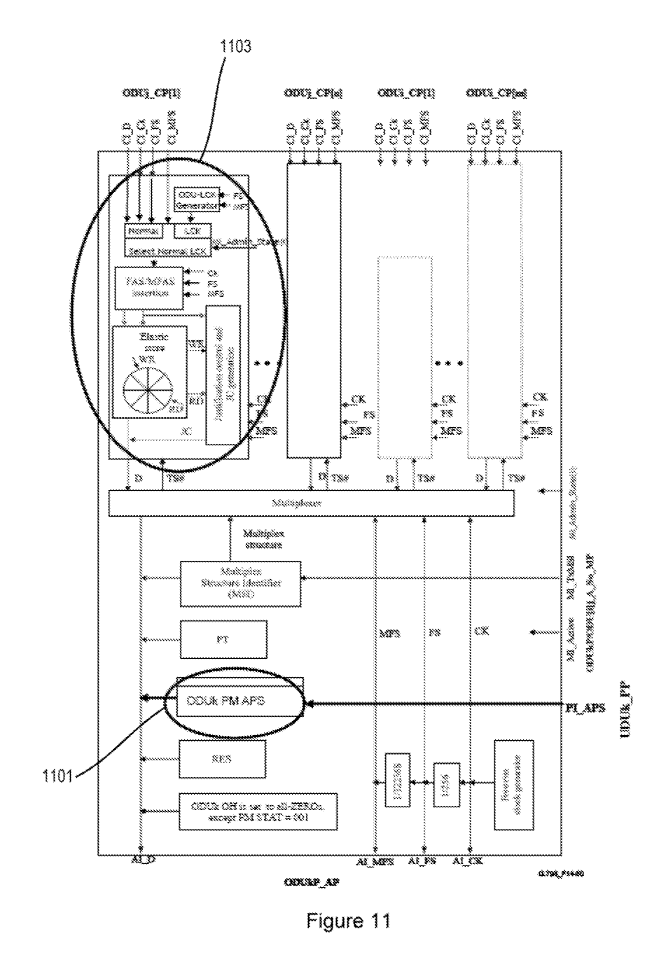

FIG. 10a shows a node 1001 of an OTN network according to an embodiment of the invention. The node 1001 may be provided at a head-end (also known as a transmitting end or source end). The node 1001 comprises one or more input interface 1003 for receiving one or more lower order optical channel data unit (LO-ODU) traffic signals 1005, and an output interface 1007 for outputting a higher order optical channel data unit (HO-ODU) traffic signal 1009. A multiplexer 1011 is adapted to multiplex or combine the one or more LO-ODUk traffic signals 1005 into the HO-ODUk traffic signal 1009. A processor 1013 is adapted to control the operation of the multiplexer 1011, such that protocol information for bidirectional protection switching is mapped or inserted into the respective header portion of the one or more LO-ODU traffic signals. For example, the protocol information may be mapped into an automatic protection switching (APS) data portion (for example APS byte or bytes) of each of the one or more LO-ODU traffic signals.

FIG. 10b shows a node 1021 of an OTN network according to another embodiment of the invention. The node 1021 may be provided at a tail-end (also known as a receiving end or sink end). The node 1021 comprises an input interface 1023 for receiving a higher order optical channel data unit (HO-ODU) traffic signal 1025, which comprises one or more lower order optical channel data unit (LO-ODU) traffic signals, and one or more output interface 1027 for outputting one or more LO-ODU traffic signals 1029. A demultiplexer 1031 is adapted to demultiplex or separate the one or more LO-ODUk traffic signals 1029 from the HO-ODUk traffic signal 1025. A processor 1033 is adapted to control the operation of the demultiplexer 1031, such that protocol information for bidirectional protection switching is unmapped or extracted from a respective header portion of the one or more LO-ODU traffic signals, for example from the automatic protection switching (APS) data portion (for example APS byte or bytes) of the one or more LO-ODU traffic signals.

It is noted that a node in the OTN network may comprise the features of FIGS. 10a and 10b in combination, when such a node is able to operate as both a head-end and tail-end, for example during bidirectional operation.

FIG. 10c shows an optical transport network according to an embodiment of the present invention. The optical transport network comprises a first node 1001 and a second node 1021, for example corresponding to the nodes shown in FIGS. 10a and 10b, respectively. The first node 1001 and the second node 1021 communicate one or more lower order optical channel data unit (LO-ODU) traffic signals (1005, 1029) via a higher order optical channel data unit (HO-ODU) traffic signal (1009/1025). A processor (1013, 1033) is adapted to modify an adaptation function between a lower order optical channel data unit (LO-ODU) traffic signal (1005, 1029) and the higher order optical channel data unit (HO-ODU) traffic signal (1009/1025) to enable protocol information for bidirectional protection switching to be conveyed in the respective one or more lower order optical channel data unit traffic signals (1005, 1029). The processor can comprise a first processor 1013 adapted to modify an adaptation function at an LO-ODU/HO-ODU interface at the first node (or head-end), and a second processor 1033 adapted to modify an adaptation function at a HO-ODU/LO-ODU interface at the second node (or tail-end).

The modifications, compared to the standard ODUk/ODUij functions are described further in FIGS. 11 to 14 below.

FIG. 11 shows an example of a source functional block diagram of a transmitting or head-end of an optical transport network, according to ITU-T G.798. As highlighted by the ellipse referenced 1101, the standard function provides to the SNC protection process the APS of the HO-ODUk. However, no LO-ODUj APS insertion is provided by the functional block processing the LO-ODUj, as highlighted by the ellipse referenced 1103.

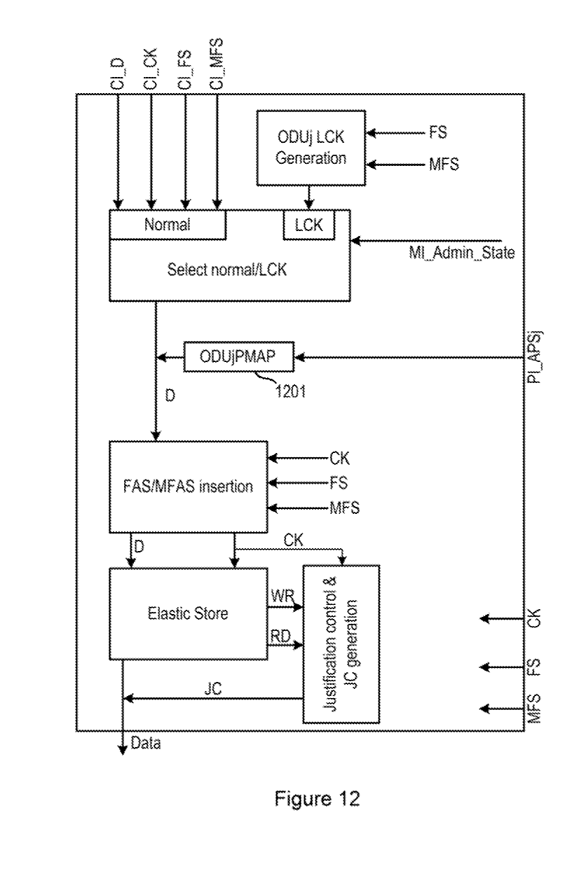

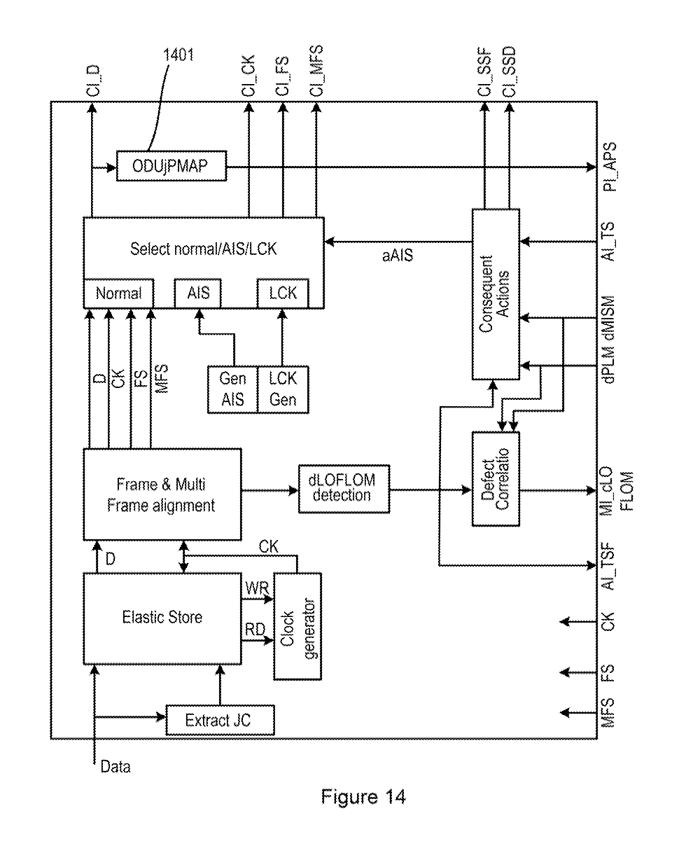

FIG. 12 shows an example of a modified source functional block of a transmitting or head-end of an optical transport network, according to an embodiment of the present invention. FIG. 12 shows how the functional block 1103 of FIG. 11 may be adapted according to an embodiment of the invention. Insertion is provided by mapping or inserting the APS data of each lower order optical channel data unit (ODUk) traffic signal, shown as reference 1201. When the LO-ODUk traffic signals are multiplexed into the HO-ODUk traffic signal the protocol information (that is encoded by the state machine that controls the protection and therefore decides which message has to be sent to the tail of the protection) PI_APS is encoded into the APS bytes of the LO-ODUk traffic signal. When the LO-ODUk traffic signals are demultiplexed from the HO-ODUk traffic signal this information/message (i.e. PI_APS described in FIG. 14 below) is extracted and sent to the state machine that controls the Sink of the protection, which, based on this information, will decide if any action is to be taken.

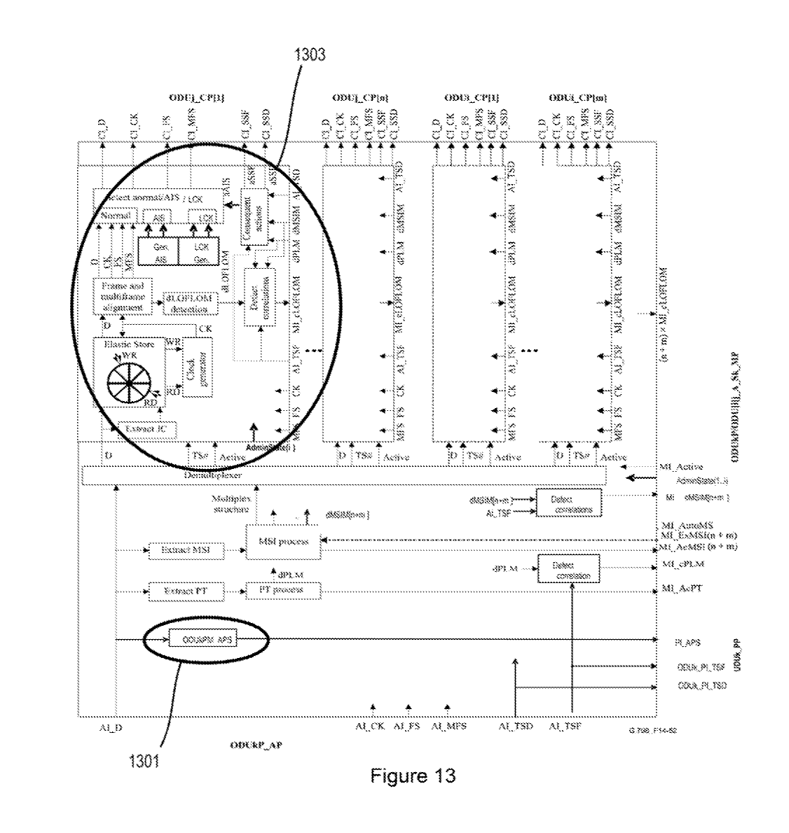

FIG. 13 shows an example of a sink functional block diagram of a receiving or tail-end of an optical transport network, according to ITU-T G.798. As highlighted by the ellipse referenced 1301, the standard function provides to the SNC protection process the APS of the HO-ODUk. However, no APS extraction is provided by the functional block processing the LO-ODUj, as highlighted by the ellipse referenced 1303.

FIG. 14 shows an example of a modified sink functional block diagram of a receiving or tail-end of an optical transport network, according to an embodiment of the present invention. FIG. 14 shows how the functional block 1303 of FIG. 13 may be adapted according to an embodiment of the invention. Extraction is provided by unmapping or extracting the APS data of each lower order optical channel data unit (ODUk) traffic signal. As noted above, when the LO-ODUk traffic signals are demultiplexed from the HO-ODUk traffic signal this information/message (i.e. PI_APS described in FIG. 14 below) is extracted and sent to the state machine that controls the Sink of the protection, which, based on this information, will decide if any action is to be taken.

It will be appreciated that a given node will have both sink and source functions when operating in a bidirectional mode, thus having the functions of FIGS. 12 and 14 in combination.

The invention has the advantage of enabling SNC/I protection for low order optical channel data unit (LO-ODUj) traffic where the server is a higher order (HO-ODUk) server.

The invention also enables 1:n bidirectional SNC/N protection switching.

Although some embodiments and Figures described above relate to various aspects of ITU-T standards as defined at present, it is noted that the embodiments of the invention are not limited to such details of the present standards. For example, the functional block diagrams shown in FIGS. 11 to 14 are only examples showing how the invention may be used to adapt the existing functional block diagrams, and it is noted that the invention can be used to adapt other functional block diagrams in a similar way.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for providing bidirectional protection switching in an optical transport network, the optical transport network comprising a first node and a second node adapted to communicate one or more lower order optical channel data unit (LO-ODU) traffic signals via a higher order optical channel data unit (HO-ODU) traffic signal, the method comprising:
modifying an adaptation function between a lower order optical channel data unit (LO-ODU) traffic signal and a higher order optical channel data unit (HO-ODU) traffic signal to enable protocol information for bidirectional protection switching to be conveyed in the respective one or more lower order optical channel data unit (LO-ODU) traffic signals; and
using the protocol information to perform bidirectional protection switching.

2. The method as claimed in claim 1, further comprising the steps of inserting the protocol information, at the first node, into a respective header portion of each of the one or more lower order optical channel data unit (LO-ODUk) traffic signals.

3. The method as claimed in claim 2, wherein the protocol information is inserted into a respective automatic protection switching, APS, header portion of each of the one or more lower order optical channel data unit (LO-ODUk) traffic signals.

4. The method as claimed in claim 1, further comprising the steps of extracting protocol information, at the second node, from a header portion of each of the one or more lower order optical channel data unit (LO-ODUk) traffic signals.

5. The method as claimed in claim 4, wherein the protocol information is extracted from an automatic protecting switching, APS, header portion of each of the one or more lower order optical channel data unit (LO-ODUk) traffic signals.

6. The method as claimed in claim 1, further comprising the step of using the extracted protocol information in a 1+1 architecture of an optical transport network, for bidirectional subnetwork connection protection switching with inherent monitoring (SNC/I).

7. The method as claimed in claim 1, further comprising the step of using the extracted protocol information in a 1:n architecture of an optical transport network, for bidirectional subnetwork connection protection switching with non-intrusive monitoring (SNC/N).

8. An optical transport network for providing bidirectional subnetwork connection protection switching, the network comprising:
a first node and a second node adapted to communicate one or more lower order optical channel data unit (LO-ODU) traffic signals via a higher order optical channel data unit (HO-ODU) traffic signal; and
a processor adapted to modify an adaptation function between a lower order optical channel data unit (LO-ODU) traffic signal and the higher order optical channel data unit (HO-ODU) traffic signal to enable protocol information for bidirectional protection switching to be conveyed in the respective one or more lower order optical channel data unit traffic signals.

9. The optical transport network as claimed in claim 8, further comprising an inserting unit and/or an extracting unit for respectively inserting and/or extracting the protocol information into and/or from a respective header portion of each of the lower order optical channel data unit (LO-ODU) traffic signals.

10. The optical transport network as claimed in claim 9, wherein the inserting unit and/or an extracting unit is adapted to insert and/or extract the protocol information into and/or from a respective automatic protection switching (APS) header portion of each of the lower order optical channel data unit (LO-ODU) traffic signals.

11. A node for use in an optical transport network, the node comprising:
one or more input interface for receiving one or more lower order optical channel data unit traffic signals;
an output interface for outputting a higher order optical channel data unit traffic signal;
a multiplexer adapted to multiplex the one or more lower order optical channel data traffic signals into the higher order optical channel data unit traffic signal; and
a processor adapted to control the operation of the multiplexer, such that protocol information for bidirectional protection switching is mapped into a respective header portion of the one or more lower order optical channel data unit traffic signals.

12. The node as claimed in claim 11, wherein the processor is adapted to map the protocol information into an automatic protection switching, APS, header portion of each of the respective lower order optical channel data unit traffic signals.

13. A method in a node of an optical transport network, the method comprising:
receiving one or more lower order optical channel data unit (LO-ODU) traffic signals;
multiplexing the one or more lower order optical channel data (LO-ODU) traffic signals into a higher order optical channel data unit (HO-ODU) traffic signal; and
outputting the higher order optical channel data unit (HO-ODU) traffic signal,
wherein the multiplexing step comprises mapping protocol information for bidirectional protection switching into a respective header portion of the one or more lower order optical channel data unit (LO-ODU) traffic signals.

14. The method as claimed in claim 13, wherein the mapping step comprises mapping the protocol information into an automatic protection switching, APS, header portion of each of the respective lower order optical channel data unit traffic signals.

15. A node for use in an optical transport network, the node comprising:
an input interface for receiving a higher order optical channel data unit traffic signal, which comprises one or more lower order optical channel data unit (LO-ODU) traffic signals;
one or more output interface for outputting one or more lower order optical channel data unit traffic signals;
a demultiplexer adapted to demultiplex the one or more traffic signals from the higher order optical channel data unit traffic signal; and
a processor adapted to control the operation of the demultiplexer, such that protocol information for bidirectional protection switching is unmapped from a respective header portion of the one or more lower order optical channel data unit traffic signals.

16. The node as claimed in claim 15, wherein the processor is adapted to unmap the protocol information from an automatic protection switching, APS, header portion of each of the respective lower order optical channel data unit traffic signals.

17. A method in a node of an optical transport network, the method comprising:
receiving a higher order optical channel data unit traffic signal, which comprises one or more lower order optical channel data unit (LO-ODU) traffic signals;
demultiplexing the one or more lower order optical channel data unit (LO-ODU) traffic signals from the higher order optical channel data unit (HO-ODU) traffic signal; and
outputting one or more lower order optical channel data unit traffic signals,
wherein the demultiplexing step comprises unmapping protocol information for bidirectional protection switching from a respective header portion of the one or more lower order optical channel data unit (LO-ODU) traffic signals.

18. The method as claimed in claim 17, wherein demultiplexing step comprises unmapping the protocol information from an automatic protection switching, APS, header portion of each of the respective lower order optical channel data unit traffic signals.

19. The method as claimed in claim 17 or 18, further comprising the step of using the unmapped protocol information in a 1+1 architecture of an optical transport network, for bidirectional subnetwork connection protection switching with inherent monitoring (SNC/I).

20. The method as claimed in claim 17, further comprising the step of using the unmapped protocol information in a 1:n architecture of an optical transport network, for bidirectional subnetwork connection protection switching with non-intrusive monitoring (SNC/N).
